(19) United States
(12) Patent Application Publication
(10) Pub. No.: US 2025/0216589 A1
(43) Pub. Date: Jul. 3, 2025

(54) DISPLAY PANEL

(71) Applicant: AUO Corporation, Hsinchu (TW)

(72) Inventors: Chia-Chun Hsu, Hsinchu (TW); Chen-Hao Chiang, Hsinchu (TW); Yu-Ping Kuo, Hsinchu (TW); Hsiao-Wei Cheng, Hsinchu (TW)

(73) Assignee: AUO Corporation, Hsinchu (TW)

(21) Appl. No.: 18/650,110

(22) Filed: Apr. 30, 2024

(30) Foreign Application Priority Data
Jan. 3, 2024 (TW) 113100199

(51) Int. Cl. G02B 5/20; G02B 7/00; G06F 3/041

(52) U.S. Cl. CPC G02B 5/201; G02B 7/008; G06F 3/0412

(57) ABSTRACT

A display panel including a first substrate, a pixel-array layer, and a color-resist layer is disclosed. The pixel-array layer includes multiple first signal lines, multiple second signal lines, and multiple third signal lines. Each of the first signal lines corresponds to a common border between multiple first color resists and multiple second color resists. Each of the second signal lines corresponds to a common border between multiple third color resists and multiple first color resists. Each of the third signal lines corresponds to a common border between multiple second color resists and multiple third color resists. Reflected light coming from the first signal lines, reflected light coming from the second signal lines, and reflected light coming from the third signal lines are mixed to form white light.

### CROSS-REFERENCE TO RELATED APPLICATION

This application claims the priority benefit of Taiwan application serial no. 113100199, filed on Jan. 3, 2024. The entirety of the above-mentioned patent application is hereby incorporated by reference herein and made a part of this specification.

### BACKGROUND

### Technical Field

This disclosure relates to a display panel.

### Description of Related Art

Capacitive touch screen technology brings a new dimension to smartphones and tablets, and is widely used in laptops, desktop monitors, and all-in-one computers. Turning a display into a “touchpad” requires a combination of two distinct functions: display and touch. In the past, touch sensors were added to displays by “stacking” them on top of each other. Recent technologies have developed embedded displays that integrate touch sensors directly into the display. However, the touch signal lines configured in the pixel-array layer may cause problems such as chromatic aberration, dark-state light leakage, and contrast reduction in front/side views.

### SUMMARY

The disclosure provides a display panel in which reflections from each signal line do not cause chromatic aberration at side viewing angles, and in which problems of dark-state light leakage and contrast reduction at front/side viewing angles may be avoided.

According to a first embodiment of the disclosure, a display panel is provided, including a first substrate, a pixel-array layer, and a color-resist layer. The first substrate has a first surface. The pixel-array layer is disposed on the first surface and includes multiple first signal lines, multiple second signal lines, and multiple third signal lines. The color-resist layer is disposed on the pixel-array layer and includes multiple pixel units. The pixel units are arranged sequentially in a first direction, and each of the pixel units includes a first color resist, a second color resist, and a third color resist arranged sequentially in the first direction. Each of the first signal lines corresponds to a common border of the first color resists and the second color resists, each of the second signal lines corresponds to a common border of the third color resists and the first color resists, and each of the third signal lines corresponds to a common border of the second color resists and the third color resists. The display panel includes a first region, a second region, and a third region arranged sequentially in the first direction. The first region, the second region, and the third region each has M pixel units in the first direction. The first region is configured with N first signal lines, the second region is configured with N second signal lines, and the third region is configured with N third signal lines. M and N are positive integers, and N is less than or equal to M. The first region does not have the second signal line and the third signal line, the second region does not have the first signal line and the third signal line, and the third region does not have the first signal line and the second signal line.

According to a second embodiment of the disclosure, a display panel is provided, including a first substrate, a pixel-array layer, and a color-resist layer. The first substrate has a first surface. The pixel-array layer is disposed on the first surface and includes multiple signal lines. The color-resist layer is disposed on the pixel-array layer and includes multiple pixel units. The pixel units are arranged in a first direction and a second direction perpendicular to the first direction, and each of the pixel units includes a first color resist, a second color resist, and a third color resist arranged sequentially in the first direction. The first color resist, the second color resist, and the third color resist have different colors. Each of the signal lines includes multiple first line segments, multiple second line segments, and multiple third line segments in the second direction. Each of the first line segments corresponds to a common border of N first color resists and N second color resists, each of the second line segment corresponds to a common border of N second color resists and N third color resists, each of the third line segments corresponds to a common border of N third color resists and N first color resists, and N is a positive integer.

According to a third embodiment of the disclosure, a display panel is provided, including a first substrate, a pixel-array layer, and a color-resist layer. The first substrate has a first surface. The pixel-array layer is disposed on the first surface and includes multiple first signal lines and multiple second signal lines. The color-resist layer is disposed on the pixel-array layer and includes multiple first color resists, multiple second color resists, and multiple third color resists. The first color resist, the second color resist, and the third color resist have different colors. Each of the first signal lines corresponds to a common border between adjacent two of the third color resists, and each of the second signal lines corresponds to a common border between adjacent two of the first color resists. The first signal lines and the second signal lines are alternately arranged in a first direction. In the first direction, a region between the adjacent first signal line and the second signal line corresponds to the second color resists.

According to a fourth embodiment of the disclosure, a display panel is provided, including a first substrate, a pixel-array layer, and a color-resist layer. The first substrate has a first surface. The pixel-array layer is disposed on the first surface and includes multiple first signal lines, multiple second signal lines, and multiple third signal lines. The color-resist layer is disposed on the pixel-array layer and includes multiple first color resists, multiple second color resists, and multiple third color resists. The first color resist, the second color resist, and the third color resist have different colors. Each of the first signal lines corresponds to a common border between adjacent two of the third color resists, each of the second signal lines corresponds to a common border between adjacent two of the second color resists, and each of the third signal lines corresponds to a common border between adjacent two of the first color resists. The first signal line, the second signal line and the third signal line are arranged sequentially in the first direction, and a distance between the adjacent first signal line and the second signal line is equal to a distance between the adjacent second signal line and the third signal line. In the first direction, a region between the adjacent first signal line and the second signal line corresponds to the first color resists, and a region between the adjacent second signal line and the third signal line corresponds to the third color resists.

Based on the above, in the first to fourth embodiments of the disclosure, multiple special signal line configuration methods are provided. The reflection from each signal line does not cause chromatic aberration at side viewing angles, and avoids the problem of dark-state light leakage and contrast reduction at front/side viewing angles.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1A is a schematic diagram of a display panel according to an embodiment of the disclosure.

FIG. 1B is a cross-sectional schematic diagram of a display panel according to an embodiment of the disclosure.

FIG. 1C is a schematic diagram of a display panel according to an embodiment of the disclosure.

FIG. 2 is a schematic diagram of a display panel according to an embodiment of the disclosure.

FIG. 3A is a schematic diagram of a display panel according to a first embodiment of the disclosure.

FIG. 3B is a schematic diagram of a display panel according to another embodiment of the disclosure.

FIG. 4 is a schematic diagram of a display panel according to a second embodiment of the disclosure.

FIG. 5 is a schematic diagram of a display panel according to a third embodiment of the disclosure.

FIG. 6 is a schematic diagram of a display panel according to the fourth embodiment of the disclosure.

### DESCRIPTION OF THE EMBODIMENTS

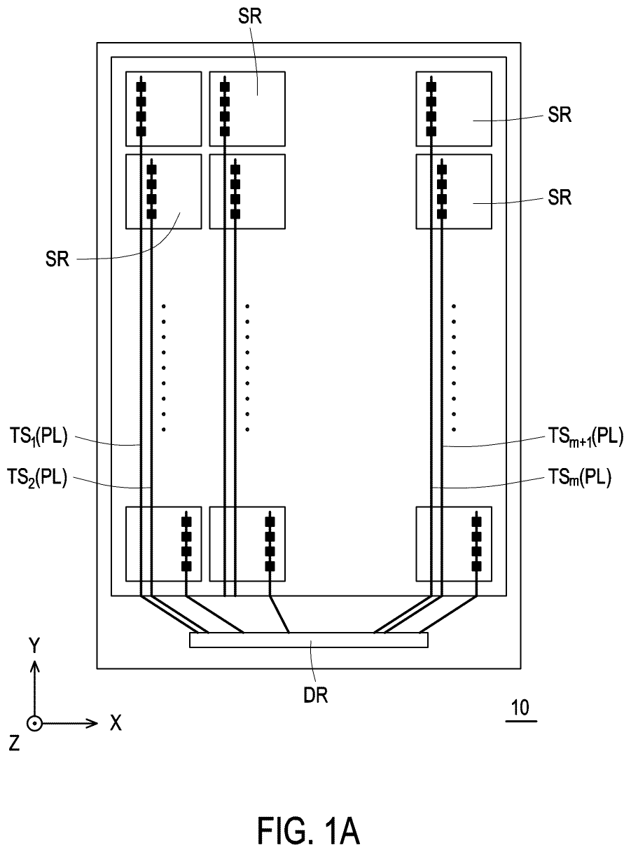

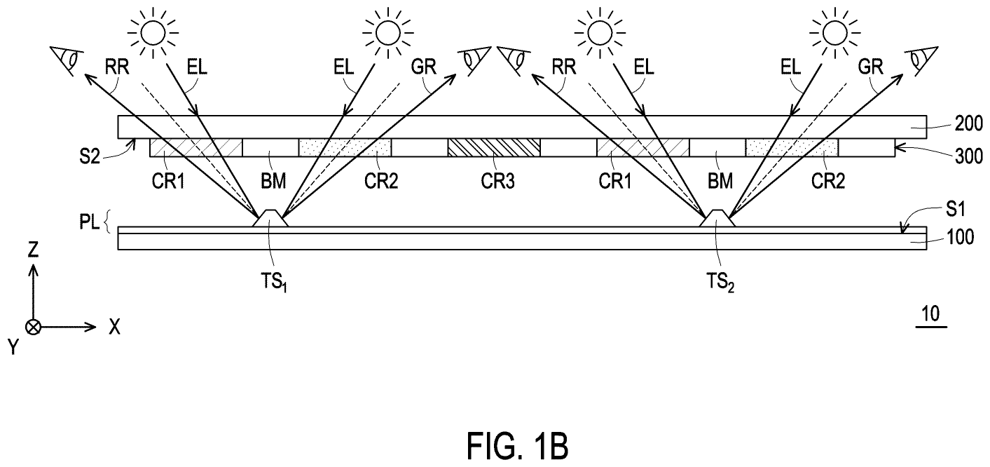

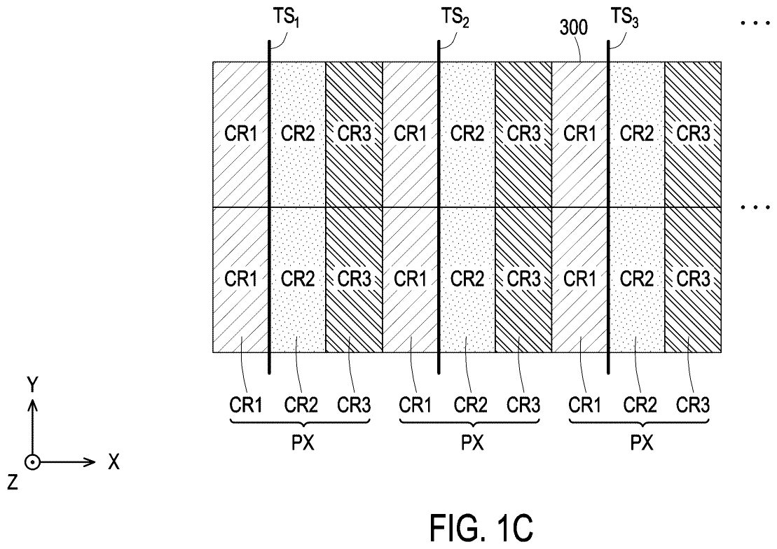

Referring to FIG. 1A, FIG. 1B, and FIG. 1C, a display panel 10 includes a first substrate 100, a pixel-array layer PL, a second substrate 200, and a color-resist layer 300. The first substrate 100 has a first surface S1. The second substrate 200 has a second surface S2. The pixel-array layer PL is disposed on the first surface S1 and includes multiple gate lines and multiple data lines of a TFT array, as well as multiple signal lines TS₁, TS₂ . . . TSₘ, TSₘ₊₁. . . . It should be noted that the signal lines TS₁, TS₂ . . . TSₘ, TSₘ₊₁ . . . are not the gate lines and data lines of the TFT array. Moreover, for ease of understanding, the gate lines and data lines of the TFT array are not shown.

The color-resist layer 300 is disposed on the second surface S2 and is located above the pixel-array layer PL. The display panel 10 may be implemented as an embedded touch panel. The signal lines TS₁, TS₂ . . . TSₘ, TSₘ₊₁ . . . are touch signal lines, which are respectively connected between multiple touch sensors SR and a controller DR. However, the disclosure is not limited thereto. In some embodiments, the display panel 10 is not a touch panel, and the signal lines TS, TS₂ . . . TSₘ, TSₘ₊₁ . . . may be heating lines for heating.

The color-resist layer 300 includes multiple pixel units PX. The pixel units PX are arranged sequentially in the X direction, and each of the pixel units PX includes a first color resist CR1, a second color resist CR2, and a third color resist CR3 arranged sequentially in the X direction, where colors of the first color resist CR1, the second color resist CR2, and the third color resist CR3 are different. In this embodiment, the colors of the first color resist CR1, the second color resist CR2, and the third color resist CR3 are red, green, and blue respectively, but they are not limited thereto. In some embodiments, the colors of the first color resist CR1, the second color resist CR2, and the third color resist CR3 are green, blue. and red respectively. In some embodiments, the colors of the first color resist CR1, the second color resist CR2, and the third color resist CR3 are blue, red, and green respectively.

As shown in FIG. 1B, each of the signal line TS₁, TS₂ . . . TSₘ, TSₘ₊₁ . . . has a taper due to the limitation of metal etching process. In such a case, when ambient light EL (white light) is incident on the display panel 10, the ambient light EL is reflected from a side of the each of the signal lines TS₁, TS₂ . . . TSₘ, TSₘ₊₁ . . . and emitted from the display panel 10, and is formed into light having a color with the color resist that the ambient light EL passes through.

In the embodiments of FIG. 1A, FIG. 1B and FIG. 1C, the each of the signal lines TS₁, TS₂ . . . TSₘ, TSₘ₊₁ . . . is disposed below a black matrix BM at a common border of the first color resist CR1 and the second color resist CR2. Spacers may be disposed at positions below the black matrix BM and where the signal lines TS₁, TS₂ . . . TSₘ, TSₘ₊₁ . . . are not disposed, but are not limited thereto. Thus, as shown in FIG. 1B, when a user views the display panel 10 from the +X direction toward the −X direction at a side viewing angle, the side of the each of the signal lines TS¹, TS₂ . . . TSₘ, TSₘ₊₁ . . . facing the +X direction reflects the ambient light EL, and the user sees reflected light GR having the color of the second color resist CR2, for example, green reflected light GR. Similarly, when the user views the display panel 10 from the −X direction toward the +X direction at a side viewing angle, the side of the each of the signal lines TS₁, TS₂ . . . TSₘ, TSₘ₊₁ . . . facing the −X direction reflects the ambient light EL, and the user sees reflected light RR having the color of the first color resist CR1, for example, red reflected light RR. The reflected light having the colors may cause the display panel 10 to have chromatic aberration at the side viewing angle.

In order to fully illustrate various implementation aspects of the disclosure, other embodiments of the disclosure are described below. It should be noted that the following embodiments are different from the foregoing embodiments in the configuration of the signal lines, and the description of the same technical content is omitted. For descriptions of the omitted parts, please refer to the foregoing embodiments. In addition, the following embodiments also use the reference numerals and part of the contents of the previous embodiments, and use the same reference numerals to represent the same or similar components.

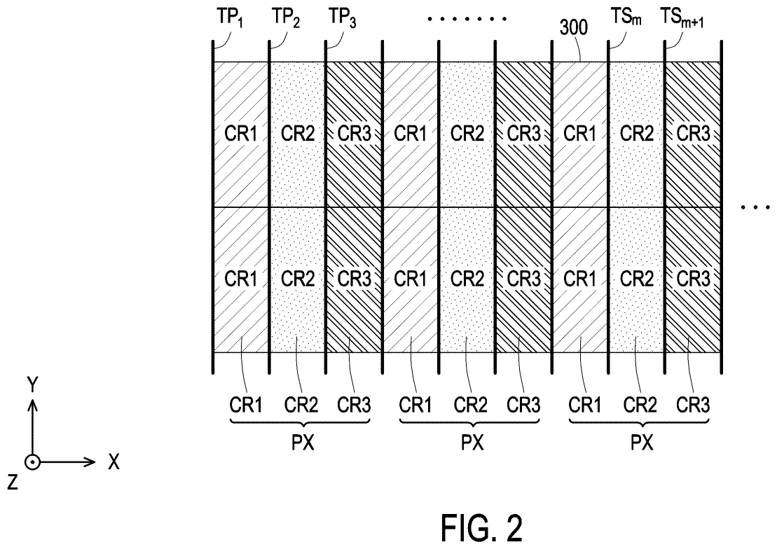

Referring to FIG. 1A and FIG. 2, in another embodiment of the disclosure, the signal lines TS₁, TS₂ . . . TSₘ, TSₘ₊₁ . . . of the display panel 10 are sequentially disposed below the black matrixes BM at the common borders of the adjacent color resists CR1, CR2, and CR3. In such a case, when the user views the display panel 10 from the +X direction toward the −X direction at a side viewing angle, the sides of the signal lines TS₁, TS₂ . . . TSₘ, TSₘ₊₁ . . . facing the +X direction generate reflected light having the color of the first color resistance CR1, a second color resistance CR2, a third color resistance CR3, a first color resist CR1, the second color resist CR2, the third color resist CR3 . . . respectively, for example, red reflective light, green reflective light, blue reflective light, red reflective light, green reflective light, blue reflective light, etc. . . . respectively. Thus, the color light is mixed into white reflected light. Similarly, when the user views the display panel 10 from the −X direction toward the +X direction at a side viewing angle, the user also sees white reflected light. It should be noted that compared with the display panel shown in FIG. 1C, the display panel of this embodiment does not have chromatic aberration at side viewing angle due to the reflection of the each of the signal lines.

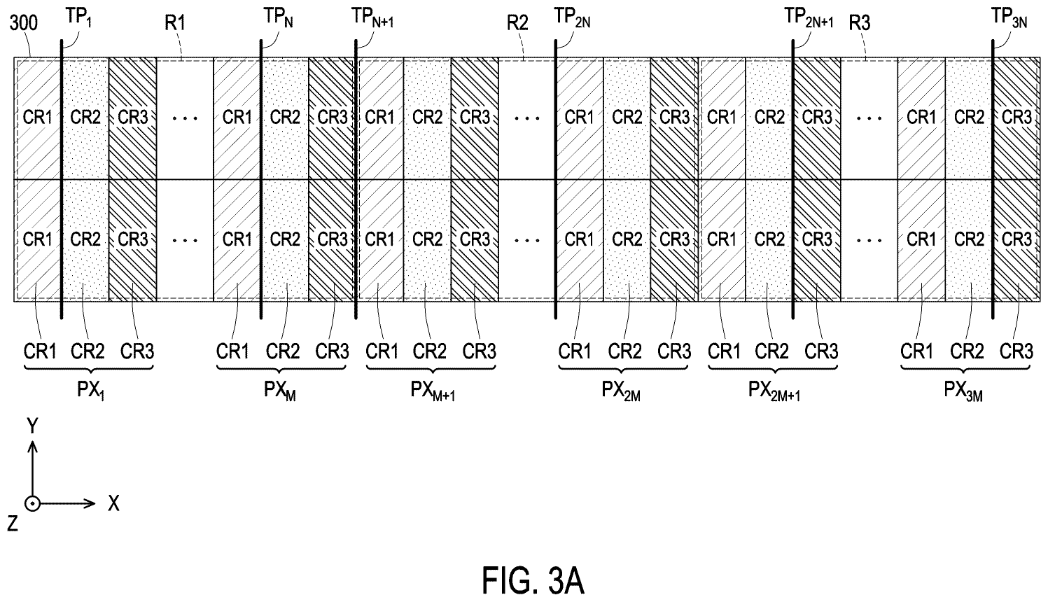

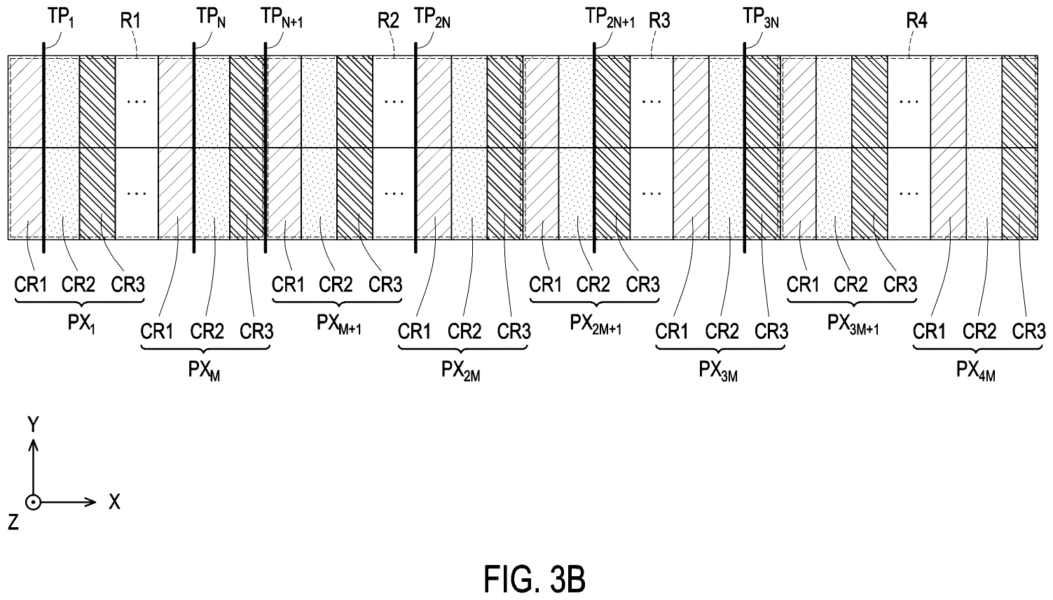

Referring to FIG. 1A and FIG. 3A, in the first embodiment of the disclosure, the display panel 10 includes a first region R1, a second region R2, and a third region R3 sequentially arranged in the X direction. The first region R1, the second region R2, and the third region R3 each have M pixel units in the X direction. Specifically, the first region R1 has pixel units PX₁, PX₂, PX₃ . . . PX_{M} in the X direction, the second region R2 has the pixel units PX_{M+1}, PX_{M+2}, PX_{M+3} . . . PX_{2M} in the X direction, and the third region R3 has pixel units PX_{2M+1}, PX_{2M+2}, PX_{2M+3} . . . PX_{3M}. M is a positive integer.

The display panel 10 also includes N first signal lines TP₁, TP₂, TP₃ . . . TP_{N}, N second signal lines TP_{N+1}, TP_{N+2}, TP_{N+3} . . . TP_{2N}, and N third signal lines TP_{2N+1}, TP_{2N+2}, TP_{2N+3} . . . TP_{3N}. Each of the first signal lines TP₁, TP₂, TP₃ . . . TP_{N} is disposed in the first region R1, and is disposed below the common border of the first color resists CR1 and the second color resists CR2 in the first region R1. Each of the second signal lines TP_{N+1}, TP_{N+2}, TP_{N+3} . . . TP_{2N} is disposed in the second region R2, and is disposed below the common border of the third color resists CR3 and the first color resists CR1 in the second region R2. Each of the third signal lines TP_{2N+1}, TP_{2N+2}, TP_{2N+3} . . . TP_{3N} is disposed in the third region R3, and is disposed below the common border of the second color resists CR2 and the third color resists CR3 in the third region R3. N is a positive integer, and N is less than or equal to M.

In some embodiments, N equals M. That is, one of the first signal lines TP₁, TP₂, TP₃ . . . TP_{N} is disposed below the common border of the each of the first color resists CR1 and the second color resists CR2 in the first region R1, one of the second signal lines TP_{N+1}, TP_{N+2}, TP_{N+3} . . . TP_{2N} is disposed at the common border of the each of the third color resists CR3 and the first color resists CR1 in the second region R2, and one of the third signal lines TP_{2N+1}, TP_{2N+2}, TP_{2N+3} . . . TP_{3N} is disposed at the common border of the each of the second color resists CR3 and the third color resists CR3 in the third region R2.

Accordingly, when the user views the display panel 10 from the +X direction toward the −X direction at a side viewing angle, the sides of the first signal lines TP₁, TP₂, TP₃ . . . TP_{N} facing the +X direction respectively generates reflected light having the color of the second resistor CR2, e.g., green reflected light; the sides of the second signal lines TP_{N+1}, TP_{N+2}, TP_{N+3} . . . TP_{2N} facing the +X direction respectively generates reflected light having the color of the first color resist CR1, e.g., red reflected light; the sides of the third signal lines TP_{2N+1}, TP_{2N+2}, TP_{2N+3} . . . TP_{3N} facing the +X direction respectively generates reflected light having the color of the third color resist CR3, e.g., blue reflected light.

Similarly, when the user views the display panel 10 from the −X direction toward the +X direction at a side viewing angle, the sides of the first signal lines TP₁, TP₂, TP₃ . . . TP_{N} facing the −X direction respectively generates reflected light having the color of the first resistor CR1, e.g., red reflected light; the sides of the second signal lines TP_{N+1}, TP_{N+2}, TP_{N+3} . . . TP_{2N} facing the −X direction respectively generates reflected light having the color of the third color resist CR3, e.g., blue reflected light; the sides of the third signal lines TP_{2N+1}, TP_{2N+2}, TP_{2N+3} . . . TP_{3N} facing the −X direction respectively generates reflected light having the color of the second color resist CR2, e.g., green reflected light.

In some preferred embodiments, N is equal to M and less than or equal to 30. When the user views the display panel 10 from the +X direction toward the −X direction at a side viewing angle, the green reflected light from the first region R1, the red reflected light from the second region R2, and the blue reflected light from the third region R3 are mixed to form white light. Similarly, when the user views the display panel 10 from the −X direction toward the +X direction at a side viewing angle, the red reflected light from the first region R1, the blue reflected light from the second region R2, and the green reflected light from the third region R3 are mixed to form white light. Thus, compared with the display panel shown in FIG. 1C, the display panel of this embodiment does not have chromatic aberration at side viewing angle due to the reflection of the each of the signal lines.

It should also be noted that there are no second signal lines TP_{N+1}, TP_{N+2}, TP_{N+3} . . . TP_{2N} and third signal lines TP_{2N+1}, TP_{2N+2}, TP_{2N+3} . . . TP_{3N} in the first region R1 of the display panel 10 of this embodiment, there are no first signal lines TP₁, TP₂, TP₃ . . . TP_{N} and third signal lines TP_{2N+1}, TP_{2N+2}, TP_{2N+3} . . . TP_{3N} in the second region R2, and there are no first signal lines TP₁, TP₂, TP₃ . . . TP_{N} and second signal lines TP_{N+1}, TP_{N+2}, TP_{N+3} . . . TP_{2N} in the third region R3. Compared with the embodiment shown in FIG. 2, where the signal lines TS, TS₂ . . . TSₘ, TSₘ₊₁ . . . are all disposed below the black matrixes BM at the common borders of the adjacent color resists CR1, CR2, and CR3, the distribution density of signal lines TP₁ . . . TP_{N}, TP_{N+1} . . . TP_{2N}, TP_{2N+1} . . . TP_{3N} in the embodiment shown in FIG. 3A is reduced by one-third. This may avoid the problem of dark-state light leakage and contrast reduction at front/side viewing angles caused by high distribution density of the signal lines. In some embodiments, contrast at a center (front viewing angle) of the display panel in FIG. 3A is increased by 8% compared to the contrast at the center of the display panel in FIG. 2.

In some preferred embodiments, N is equal to M and less than or equal to 25. In some more preferred embodiments, N is equal to M and less than or equal to 20.

In some embodiments, N may be less than M. For example, M=20, N=10, the spacing between two adjacent first signal lines TP₁, TP₂, TP₃ . . . TP_{N} is the same, the spacing between two adjacent second signal lines TP_{N+1}, TP_{N+2}, TP_{N+3} . . . TP_{2N} is the same, and the spacing between two adjacent third signal lines TP_{2N+1}, TP_{2N+2}, TP_{2N+3} . . . TP_{3N} is the same. This allows the side viewing angle to be free of chromatic aberration and further reduces the distribution density of signal lines.

FIG. 3B is a schematic diagram of a display panel according to another embodiment of the disclosure. In this embodiment, the display panel 10 includes a first region R1, a second region R2, a third region R3 and a fourth region R4 arranged sequentially in the X direction. The first region R1, the second region R2, the third region R3, and the fourth region R4 each have M pixel units in the X direction, and M is a positive integer less than or equal to 20. Specifically, the first region R1 has pixel units PX₁, PX₂, PX₃ . . . PX_{M} in the X direction, the second region R2 has the pixel units PX_{M+1}, PX_{M+2}, PX_{M+3} . . . PX_{2M} in the X direction, the third region R3 has the pixel units PX_{2M+1}, PX_{2M+2}, PX_{2M+3} . . . PX_{3M} in the X direction, and the fourth region R4 has pixel units PX_{3M+1}, PX_{3M+2}, PX_{3M+3} . . . PX_{4M} in the X direction. The first region R1, the second region R2, and the third region R3 of this embodiment have the same configuration and display effect as the first region R1, the second region R2, and the third region R3 of the first embodiment. That is, there are N first signal lines in the first region R1, N second signal lines in the second region R2, and N third signal lines in the third region R3, where N is a positive integer and is less than or equal to M. It should be noted that the fourth region R4 of this embodiment is not configured with the first signal line, the second signal line, and the third signal line. That is, the first signal line is not disposed below the common border of the first color resist CR1 and the second color resist CR2 in the fourth region R4, and the second signal line is not disposed below the common border of the third color resist CR3 and the first color resist CR1 in the fourth region R4, and the third signal line is not disposed below the common border of the second color resist CR2 and the third color resist CR3 in the fourth region R4. More specifically, the first signal line, the second signal line, and the third signal line are not disposed below the common borders between the color resists in the fourth region R4. Accordingly, the configuration provided in the embodiment may further reduce the distribution density of the signal lines than the configuration of the first embodiment, and may likewise avoid the problems of dark-state light leakage and contrast reduction at front/side viewing angles.

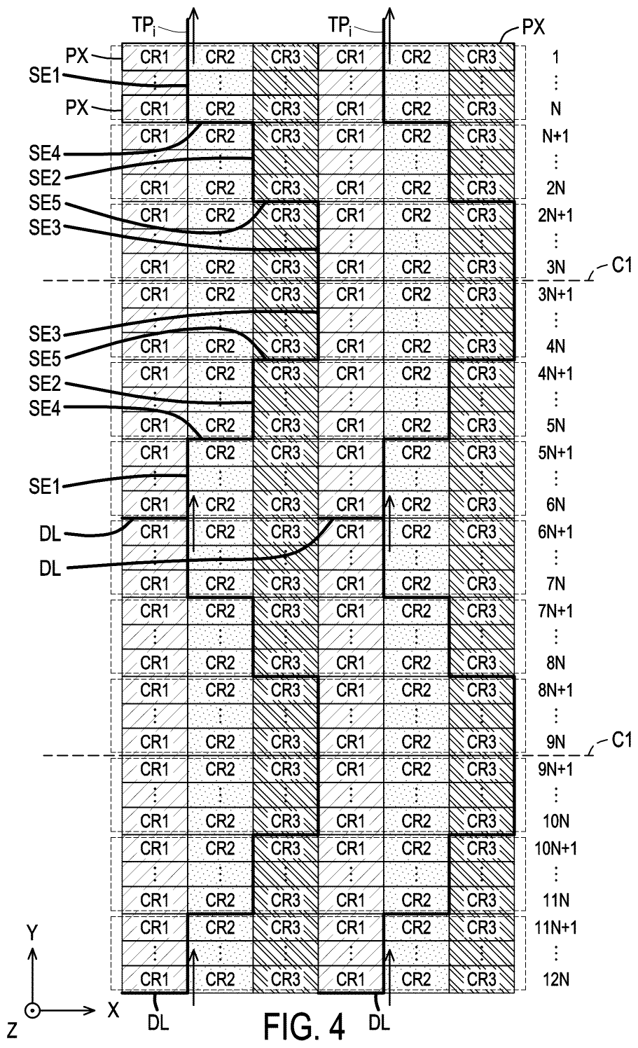

Referring to FIG. 1A and FIG. 4, in the second embodiment of the disclosure, the display panel 10 includes multiple pixel units PX arranged in the X direction and the Y direction, and each of the pixel units PX includes a first color resist CR1, a second color resist CR2, and a third color resist CR3 sequentially arranged in the X direction. The first color resist CR1, the second color resist CR2, and the third color resist CR3 have different colors.

The display panel 10 also includes multiple signal lines TPᵢ. Each of the signal lines TPᵢ includes multiple first line segments SE1, multiple second line segments SE2, and multiple third line segments SE3 in the Y direction. There is a fourth line segment SE4 between the first line segment SE1 and the second line segment SE2, and there is a fifth line segment SE5 between the second line segment SE2 and the third line segment SE3. The fourth line segment SE4 is parallel to the fifth line segment SE5.

Each of the first line segments SE1 corresponds to the common border of N first color resist CR1 and N second color resist CR2, each of the second line segments SE2 corresponds to the common border of N second color resist CR2 and N third color resist CR3, and each of the third line segments SE3 corresponds to the common border of N third color resist CR3 and N first color resist CR1, where N is a positive integer. Since a first color resist CR1, a second color resist CR2, and a third color resist CR3 have the same width in the Y direction, the length of a first line segment SE1, a second line segment SE2, and a third line segment SE3 in the Y direction are the same. In addition, each of the signal lines TPᵢ has a symmetrical structure relative to a virtual line C1, as shown in FIG. 4.

Accordingly, when the user views the display panel 10 from the +X direction toward the −X direction at a side viewing angle, the side of the first line segment SE1 facing the +X direction generates reflected light having the color of the second color resist CR2, e.g., green reflected light; the side of the second line segment SE2 facing the +X direction generates reflected light having the color of the third color resist CR3, e.g., blue reflected light; the side of the third line segment SE3 facing the +X direction generates reflected light having the color of the first color resist CR1, e.g., red reflected light.

Similarly, when the user views the display panel 10 from the −X direction toward the +X direction at a side viewing angle, the side of the first line segment SE1 facing the −X direction generates reflected light having the color of the first color resist CR1, e.g., red reflected light; the side of the second line segment SE2 facing the −X direction generates reflected light having the color of the second color resist CR2, e.g., green reflected light; the side of the third line segment SE3 facing the −X direction generates reflected light having the color of the third color resist CR3, e.g., blue reflected light.

In some preferred embodiments, N is less than or equal to 25. In some more preferred embodiments, N is less than or equal to 20. Accordingly, when the user views the display panel 10 from the +X direction toward the −X direction at a side viewing angle, the green reflected light from the first line segment SE1, the blue reflected light from the second line segment SE2, and the red reflected light from the third line segment SE3 are mixed to form white light. Similarly, when the user views the display panel 10 from the −X direction toward the +X direction at a side viewing angle, the red reflected light from the first line segment SE1, the green reflected light from the second line segment SE2, and the blue reflected light from the third line segment SE3 are mixed to form white light. Thus, compared with the display panel shown in FIG. 1C, the display panel of this embodiment does not have chromatic aberration at side viewing angle due to the reflection of the each of the signal lines.

Furthermore, compared with the distribution density of the signal lines TS₁, TS₂. . . TSₘ, TSₘ₊₁ . . . in FIG. 2, the distribution density of the signal line TPᵢ in FIG. 4 is lower, which may avoid the problem of dark-state light leakage and contrast reduction at front/side viewing angles caused by high distribution density of the signal lines.

Referring also to FIG. 4, the each of the signal lines TPᵢ also includes multiple dummy line segments DL, and electrical signals on the each of the signal lines TPᵢ are transmitted in the direction of arrows as shown in FIG. 4. There are no electrical signals on the dummy line segments DL. Since the fourth line segment SE4 is disposed between two adjacent second color resists CR2, and the fifth line segment SE5 is disposed between two adjacent third color resists CR3, by disposing the dummy line segments DL respectively between two adjacent first color resists CR1 respectively, there is no chromatic aberration when the user views the display panel 10 from the +Y direction towards the −Y direction or from the −Y direction towards the +Y direction.

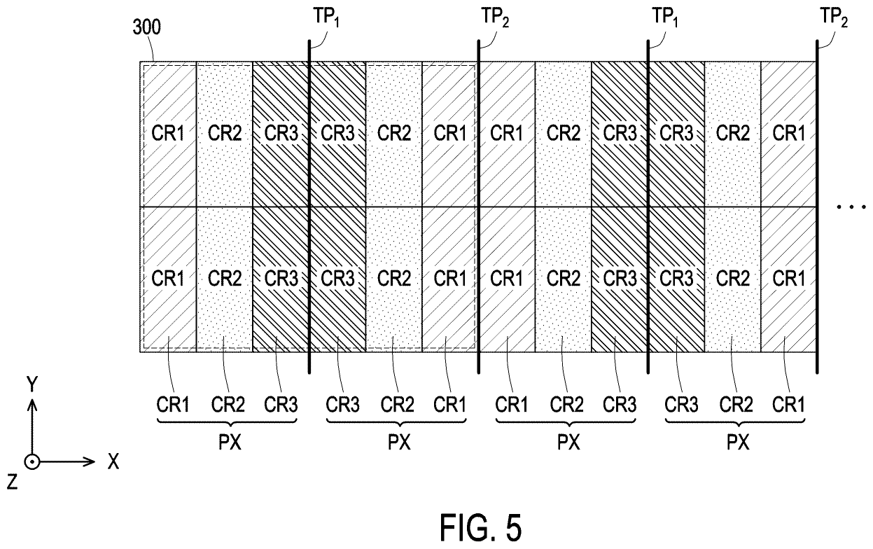

Referring to FIG. 1A and FIG. 5, in the third embodiment of the disclosure, the display panel 10 includes multiple first signal lines TP₁ and multiple second signal lines TP₂. The color-resist layer 300 includes multiple first color resists CR1, multiple second color resists CR2, and multiple third color resists CR3, where colors of the first color resists CR1, the second color resists CR2, and the third color resists CR3 are different. Each of the first signal lines TP₁ corresponds to the common border between the two adjacent third color resists CR3, and each of the second signal lines TP₂ corresponds to the common border between the two adjacent first color resists CR1. The first signal lines TP₁ and the second signal lines TP₂ are alternately arranged in the X direction, as shown in FIG. 5. Moreover, in the X direction, regions between the adjacent first signal line TP₁ and the second signal line TP₂ corresponds to multiple second color resists CR2. Accordingly, when the user views the display panel 10 from the +X direction toward the −X direction at a side viewing angle or from the −X direction toward the +X direction at a side viewing angle, the sides of the first signal lines TP₁ respectively generate reflected light having the color of the third color resist CR3, e.g., blue reflected light; the sides of the second signal lines TP₂ respectively generate reflected light having the color of the first color resist CR1, e.g., red reflected light. The blue reflected light from the first signal line TP₁ and the red reflected light from the second signal line TP₂ are mixed to form purple light.

In this embodiment, a first color resist CR1, a second color resist CR2, a third color resist CR3, a third color resist CR3, a second color resist CR2, and a first color resist CR1 are sequentially arranged in the X direction, and the arrangement is periodically repeated in the X direction. Accordingly, the distance between two adjacent first signal lines TP₁ and second signal lines TP₂ is a constant value. Therefore, when the user views the display panel 10 at a side viewing angle, the purple reflected light is evenly distributed.

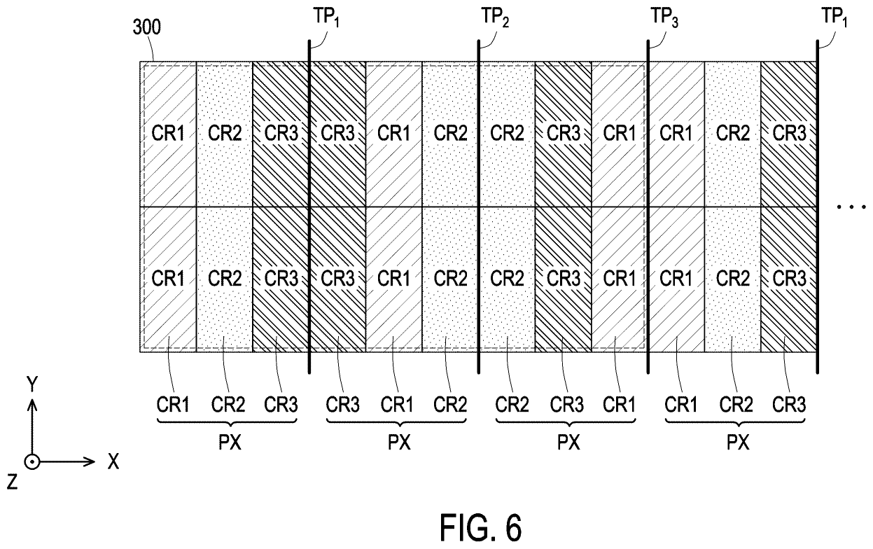

Referring to FIG. 1A and FIG. 6, in the fourth embodiment of the disclosure, the display panel 10 includes multiple first signal lines TP₁, multiple second signal lines TP₂, and multiple third signal lines TP₃. The color-resist layer 300 includes a first color resist CR1, multiple second color resists CR2, and multiple third color resists CR3, where the first color resist CR1, the second color resist CR2, and the third color resist CR3 have different colors. The each of the first signal lines TP₁ corresponds to the common border between the two adjacent third color resists CR3, the each of the second signal lines TP₂ corresponds to the common border between the two adjacent second color resists CR2, and each of the third signal lines TP₃ corresponds to the common border between the two adjacent first color resists CR1. The first signal line TP₁, the second signal line TP₂, and the third signal line TP₃ are sequentially arranged in the X direction, and the arrangement is periodically repeated in the X direction. In the X direction, regions between the adjacent first signal line TP₁ and the second signal line TP₂ corresponds to multiple first color resists CR1, and regions between the adjacent second signal line TP₂ and third signal line TP₃ corresponds to multiple third color resists CR3. Accordingly, when the user views the display panel 10 from the +X direction toward the −X direction at a side viewing angle or from the −X direction toward the +X direction at a side viewing angle, the sides of the first signal lines TP₁ respectively generate reflected light having the color of the third color resist CR3, e.g., blue reflected light; the sides of the second signal lines TP₂ respectively generate reflected light having the color of the second color resist CR2, e.g., green reflected light; the sides of the third signal lines TP₃ respectively generate reflected light having the color of the first color resist CR1, e.g., red reflected light. The blue reflected light from the first signal line TP₁, the green reflected light from the second signal line TP₂, and the red reflected light from the third signal line TP₃ are mixed to form white light.

In this embodiment, a first color resist CR1, a second color resist CR2, a third color resist CR3, a third color resist CR3, a first color resist CR1, a second color resist CR2, a second color resist CR2, a third color resist CR3, and a first color resist CR1 are arranged sequentially in the X direction, and the arrangement is periodically repeated in the X direction. Accordingly, the distance between the adjacent first signal line TP₁ and the second signal line TP₂ is equal to the distance between the adjacent second signal line TP₂ and the third signal line TP₃. Therefore, when the user views the display panel 10 at a side viewing angle, the white reflected light is evenly distributed.

To sum up, in the first to fourth embodiments of the disclosure, multiple special signal line configuration methods are provided. The reflection from each signal line does not cause chromatic aberration at side viewing angles and is evenly distributed, and avoids the problem of dark-state light leakage and contrast reduction at front/side viewing angles.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display panel, comprising:
a first substrate, having a first surface;
a pixel-array layer, disposed on the first surface, comprising a plurality of first signal lines, a plurality of second signal lines, and a plurality of third signal lines; and
a color-resist layer, disposed on the pixel-array layer, comprising a plurality of pixel units, the pixel units arranged sequentially in a first direction, and each of the pixel units comprising a first color resist, a second color resist, and a third color resist arranged sequentially in the first direction, wherein the first color resist, the second color resist, and the third color resist have different colors,
wherein each of the first signal lines corresponds to a common border of the first color resists and the second color resists, each of the second signal lines corresponds to a common border of the third color resists and the first color resists, each of the third signal lines corresponds to a common border of the second color resists and the third color resists, and
wherein the display panel comprises a first region, a second region, and a third region arranged sequentially in the first direction, the first region, the second region, and the third region each has M pixel units in the first direction, the first region is configured with N first signal lines, the second region is configured with N second signal lines, and the third region is configured with N third signal lines, wherein M and N are positive integers, and N is less than or equal to M, the first region does not have the second signal line and the third signal line, the second region does not have the first signal line and the third signal line, and the third region does not have the first signal line and the second signal line.

2. The display panel according to claim 1, wherein M is less than or equal to 20.

3. The display panel according to claim 1, wherein N equals M.

4. The display panel according to claim 1, wherein N is greater than or equal to 3, spacing between adjacent two of the first signal lines is the same, spacing between adjacent two of the second signal lines is the same, and spacing between adjacent two of the third signal lines is the same.

5. The display panel according to claim 1 further comprising a fourth region, wherein the first region, the second region, the third region, and the fourth region are disposed sequentially in the first direction, and each has M pixel units, and the fourth region does not have the first signal line, the second signal line, and the third signal line.

6. A display panel, comprising:
a first substrate, having a first surface;
a pixel-array layer, disposed on the first surface, comprising a plurality of signal lines; and
a color-resist layer, disposed on the pixel-array layer, comprising a plurality of pixel units, the pixel units arranged in a first direction and a second direction perpendicular to the first direction, each of the pixel units comprising a first color resist, a second color resist, and a third color resist arranged sequentially in the first direction, wherein the first color resist, the second color resist, and the third color resist have different colors,
wherein each of the signal lines comprises a plurality of first line segments, a plurality of second line segments, and a plurality of third line segments in the second direction, wherein each of the first line segments corresponds to a common border of N first color resists and N second color resists, each of the second line segment corresponds to a common border of N second color resists and N third color resists, each of the third line segments corresponds to a common border of N third color resists and N first color resists, and N is a positive integer.

7. The display panel according to claim 6, wherein N is less than or equal to 20.

8. The display panel according to claim 6, wherein the each of the signal lines is a touch signal line or a heating line.

9. The display panel according to claim 6, wherein the each of the signal lines comprises a plurality of dummy line segments, and no electrical signal is on the dummy line segments.

10. The display panel according to claim 6, wherein a fourth line segment is between the first line segment and the second line segment, and a fifth line segment is between the second line segment and the third line segment.

11. The display panel according to claim 10, wherein the fourth line segment is parallel to the fifth line segment.

12. The display panel according to claim 6, wherein the each of the signal lines has a symmetrical structure relative to a straight line parallel to the first direction.

13. A display panel, comprising:
a first substrate, having a first surface;
a pixel-array layer, disposed on the first surface, comprising a plurality of first signal lines and a plurality of second signal lines; and
a color-resist layer, disposed on the pixel-array layer, comprising a plurality of first color resists, a plurality of second color resists, and a plurality of third color resists, wherein the first color resist, the second color resist, and the third color resist have different colors,
wherein each of the first signal lines corresponds to a common border between adjacent two of the third color resists, and each of the second signal lines corresponds to a common border between adjacent two of the first color resists,
wherein the first signal lines and the second signal lines are alternately arranged in a first direction, and
wherein in the first direction, a region between the adjacent first signal line and the second signal line corresponds to the second color resists.

14. The display panel according to claim 13, wherein the each of the first signal lines and the each of the second signal lines are touch signal lines or heating lines.

15. The display panel according to claim 13, wherein one of the first color resists, one of the second color resists, one of the third color resists, one of the third color resists, one of the second color resists, and one of the first color resists are arranged sequentially in the first direction.

16. The display panel according to claim 13, wherein a distance between the adjacent first signal line and the second signal line is a constant value.

17. A display panel, comprising:
a first substrate, having a first surface;
a pixel-array layer, disposed on the first surface, comprising a plurality of first signal lines, a plurality of second signal lines, and a plurality of third signal lines; and
a color-resist layer, disposed on the pixel-array layer, comprising a plurality of first color resists, a plurality of second color resists, and a plurality of third color resists, wherein the first color resist, the second color resist, and the third color resist have different colors,
wherein each of the first signal lines corresponds to a common border between adjacent two of the third color resists, each of the second signal lines corresponds to a common border between adjacent two of the second color resists, and each of the third signal lines corresponds to a common border between adjacent two of the first color resists,
wherein the first signal line, the second signal line, and the third signal line are arranged sequentially in a first direction, and
wherein in the first direction, a region between the adjacent first signal line and the second signal line corresponds to the first color resists, and a region between the adjacent second signal line and the third signal line corresponds to the third color resists.

18. The display panel according to claim 17, wherein the each of the first signal lines, the each of the second signal lines, and the each of the third signal lines is a touch signal line or a heating line.

19. The display panel according to claim 17, wherein one of the first color resists, one of the second color resists, one of the third color resists, one of the third color resists, one of the first color resists, one of the second color resists, one of the second color resists, one of the third color resists, and one of the first color resists are arranged sequentially in the first direction.

20. The display panel according to claim 17, wherein a distance between the adjacent first signal line and the second signal line is equal to a distance between the adjacent second signal line and the third signal line.
